(19) United States
(12) Patent Application Publication
(10) Pub. No.: US 2014/0330561 A1
(43) Pub. Date: Nov. 6, 2014

(54) VOICE RECOGNITION METHOD AND ELECTRONIC DEVICE THEREOF

(71) Applicant: Samsung Electronics Co., Ltd., Gyeonggi-do (KR)

(72) Inventors: Jung-Min CHO, Seoul (KR); Bo-Kun CHOI, Seoul (KR)

(73) Assignee: Samsung Electronics Co., Ltd., Gyeonggi-do (KR)

(21) Appl. No.: 14/265,748

(22) Filed: Apr. 30, 2014

(30) Foreign Application Priority Data
May 3, 2013 (KR) 10-2013-0049986

(51) Int. Cl. G10L 15/26

(52) U.S. Cl. CPC G10L 15/26
USPC 704/235

(57) ABSTRACT

A voice recognition method and an electronic device thereof are provided, including executing a voice recognition function, setting a voice recognition mode based on information input from at least one sensor of the electronic device, and processing an input voice according to the set mode.

### CROSS-REFERENCE TO RELATED APPLICATION

The present application claims the benefit under 35 U.S.C. §119(a) to a Korean patent application filed in the Korean Intellectual Property Office on May 3, 2013, and assigned Serial No. 10-2013-0049986, the entire disclosure of which is hereby incorporated by reference.

### TECHNICAL FIELD

The present invention relates to portable electronic devices, and, more particularly, to voice recognition in an electronic device.

### BACKGROUND

Many recent electronic devices such as smart phones and tablet Personal Computers (PCs) provide a voice recognition function. In particular, as electronic device technology advances, the electronic device may provide various functions via voice recognition.

Typically, the voice recognition function of the electronic device is used to execute a particular function of the electronic device by converting the recognized user voice to a text, or determining the recognized user voice as a command. For example, the electronic device can receive a voice signal from the user, analyze the received voice signal, convert the corresponding voice signal to the corresponding text, and display or input the text. For example, the electronic device can receive the voice signal from the user, analyze the received voice signal, confirm the command in the corresponding voice signal, and execute the function corresponding to the command.

Voice-to-text and voice-command signal are generally classified into separate modes (e.g., voice-to-text mode and a voice-command mode). That is, under this paradigm, a conventional electronic device is does not enable a user to freely controls all functions of the electronic device with the voice signal.

### SUMMARY

A method and apparatus for recognizing a voice in an electronic device is provided, allowing a user to freely switch between voice-to-text and voice-command modes in the electronic device.

A method and apparatus is provided for determining a voice recognition mode based on information input from at least one sensor in an electronic device.

A method and an apparatus are provided for processing an input voice signal according to a voice recognition mode in an electronic device.

A method and apparatus is provided for displaying a text corresponding to an input voice signal in an electronic device.

A method and apparatus is provided for performing a function corresponding to an input voice signal in an electronic device.

A method and apparatus is provided for ignoring an input voice signal in an electronic device.

According to one embodiment, a method for controlling an electronic device includes executing a voice recognition function; determining a voice recognition mode based on information input from at least one sensor of the electronic device, and processing an input voice according to the determined mode. The voice recognition mode includes at least one of a text display mode corresponding to the voice, an electronic device function execution mode corresponding to the voice, or a waiting mode.

According to another embodiment, an electronic device includes one or more processors, a touch-sensitive display, a microphone, a memory, and one or more programs stored in the memory and configured for execution by the one or more processors. The program includes instructions for executing a voice recognition function, determining a voice recognition mode based on information input from at least one sensor of the electronic device, and processing an input voice according to the determined mode. The voice recognition mode includes at least one of a text display mode corresponding to the voice, an electronic device function execution mode corresponding to the voice, or a waiting mode.

Other aspects and features of the invention will become apparent to those skilled in the art from the following detailed description, which, taken in conjunction with the annexed drawings, discloses example embodiments of the invention.

### BRIEF DESCRIPTION OF THE DRAWINGS

Aspects and features of the invention will be more apparent from the following description taken in conjunction with the accompanying drawings, in which:

FIG. 1A illustrates an electronic device for recognizing a voice according to one example embodiment;

FIG. 1B illustrates a processor for recognizing the voice according to one example embodiment;

FIG. 2A illustrates an example sequence of steps for processing an input voice signal according to a voice recognition mode in the electronic device according to an example embodiment;

FIG. 2B illustrates an example sequence of steps for processing the input voice signal according to the voice recognition mode in the electronic device according to an example embodiment;

FIG. 3 illustrates an example sequence of steps for processing the input voice signal based on information input from a sensor in the electronic device according to an example embodiment;

FIG. 4 illustrates a voice recognition function of the electronic device according to an example embodiment;

FIG. 5A illustrates a text display mode of the voice recognition function in the electronic device according to an example embodiment;

FIG. 5B illustrates a function execution mode of the voice recognition function in the electronic device according to an example embodiment;

FIG. 5C illustrates a waiting mode of the voice recognition function in the electronic device according to an example embodiment;

FIG. 6A, FIG. 6B and FIG. 6C illustrate a voice recognition mode determined from information input from a proximity sensor in the electronic device according to an example embodiment;

FIG. 7 illustrates the three voice recognition modes that may be toggled based on the information input from the sensor in the electronic device according to an example embodiment;

FIG. 8 illustrates the voice recognition mode activated through a motion sensor in the electronic device according to an example embodiment;

FIG. 9 illustrates the voice recognition mode activated through a motion sensor in the electronic device according to an example embodiment; and

FIG. 10 illustrates the voice recognition mode determined in the electronic device according to an example embodiment.

### DETAILED DESCRIPTION

The following description with reference to the accompanying drawings is provided to assist in a comprehensive understanding of example embodiments of the invention as defined by the claims and their equivalents. It includes various specific details to assist in that understanding but these are to be regarded as merely example. Accordingly, those of ordinary skill in the art will recognize that various changes and modifications of the embodiments described herein can be made without departing from the disclosure of the invention. In addition, descriptions of well-known functions and implementations may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of example embodiments is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Hereinafter, an electronic device embraces a mobile communication terminal, a smart phone, a tablet Personal Computer (PC), a digital camera, an MP3 player, a navigation system, a laptop, a netbook, and a computer, for supporting a voice recognition function.

Throughout the drawings, like reference numerals will be understood to refer to like parts, components and structures.

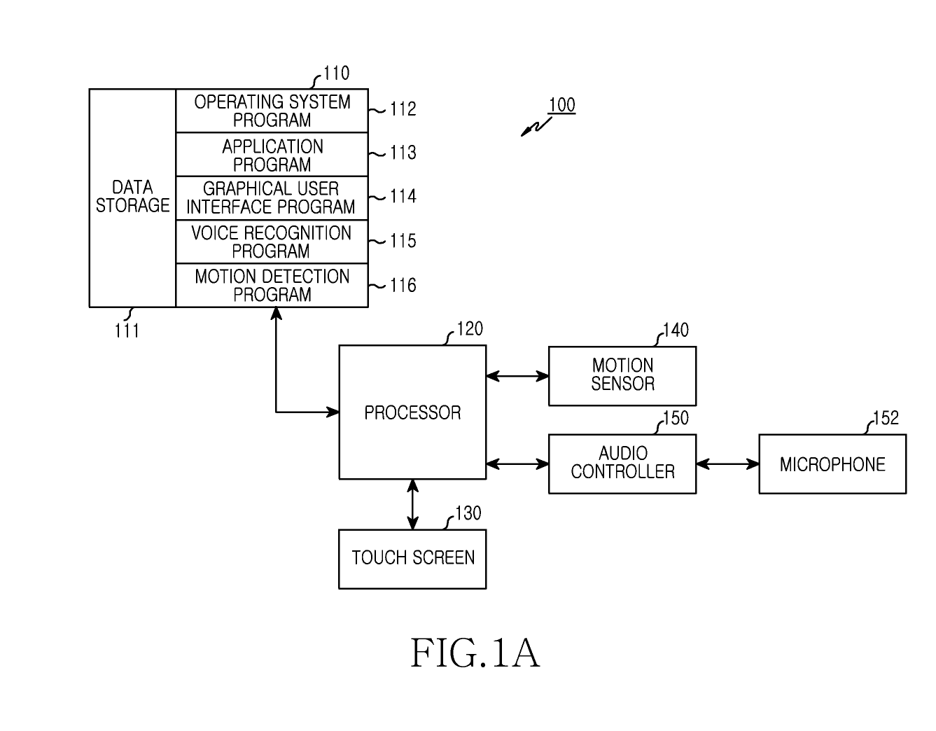

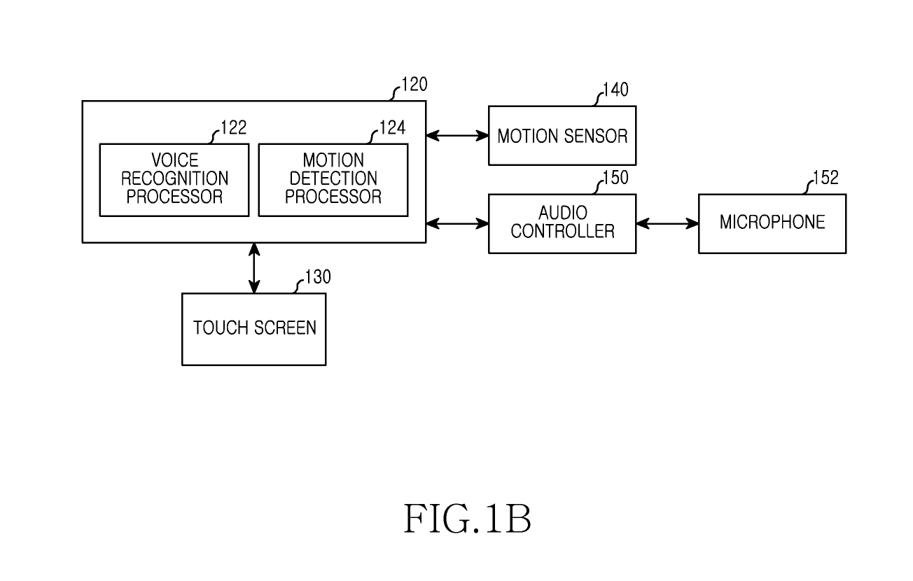

FIG. 1A is a block diagram of an electronic device for recognizing a voice according to an example embodiment.

Referring to FIG. 1A, the electronic device 100 includes a memory 110, a processor 120, a touch screen 130, a motion sensor 140, and an audio controller 150. A plurality of memories 110 and a plurality of processors 120 can be equipped.

The memory 110 includes a data storage 111, an operating system program 112, an application program 113, a graphical user interface program 114, a voice recognition program 115, and a motion detection program 116. The program being a software component can be represented as a set of instructions. Hence, the program may be referred to as an instruction set. The program may be also referred to as a module.

The memory 110 can store one or more programs including instructions for realizing example embodiments.

The data storage 111 stores data generating in the function execution corresponding to the program stored in the memory 110. The data storage 111 can store at least one mode of the voice recognition function. The voice recognition mode can include at least one of a text display mode, a function execution mode, or a waiting mode. The text display mode converts an input voice signal to a text and displays the text on the touch screen 130, and may be referred to as a dictation mode. The text display mode can be used for a text input application such as text message, memo, navigation, and Internet. The function execution mode determines a command corresponding to the voice signal and performs a function corresponding to the determined command, and may be referred to as a command mode. The function execution mode can be used to execute or terminate an application, to execute a particular function of a platform, to edit the application, or to perform a particular function. The waiting mode ignores (or discards) the voice signal input during the voice recognition without processing it. The waiting mode can be used not to convert the input voice signal to the text temporarily in the text display mode.

Further, the data storage 111 can map and store information input from at least one sensor of the electronic device 100 with the voice recognition mode. For example, the data storage 111 can map and store first information input from the sensor of the electronic device 100 with the text display mode of the voice recognition. For example, the data storage 111 can map and store second information input from the sensor of the electronic device 100 with the function execution mode of the voice recognition. For example, the data storage 111 can map and store third information input from the sensor of the electronic device 100 with the waiting mode of the voice recognition. Herein, the sensor can employ a motion sensor, such as proximity sensor, tilt sensor, and gyro sensor, for detecting the motion of the electronic device 100.

Further, the data storage 111 can store a threshold range for at least one sensor value to enter or maintain the corresponding mode with respect to the voice recognition mode. For example, to enter or maintain the text display mode, the data storage 111 can store information indicating that the sensor value input from the first sensor corresponds to a first threshold or a second threshold. For example, for the voice recognition mode, the data storage 111 can store information about a change range of at least one sensor value to switch to the corresponding mode. For example, to enter the text display mode, the data storage 111 can store information indicating that a difference between the sensor value input at a first point and the sensor value input at a second point is greater than or equal to the threshold.

The data storage 111 can include a buffer for temporarily storing the received voice signal until the voice recognition mode is determined.

In addition, the data storage 111 can store a command and a special character keyword of the voice recognition function. The command indicates a word for executing the function of the electronic device 100 corresponding to the received voice signal without converting and displaying the received voice signal to the text, and the special character keyword indicates a word for displaying a special character corresponding to the received voice signal without converting and displaying the received voice signal to the text. For example, the data storage 111 can store the word such as cut, copy, paste, and delete, as the voice recognition command. For example, the data storage 111 can store the word such as question mark, exclamation point, and dot, as the special character keyword of the voice recognition.

The operating system program 112 (e.g., the embedded operating system such as WINDOWS, LINUX, Darwin, RTXC, UNIX, OS X, or VxWorks) includes various software components for controlling general system operations. These include, e.g., memory management and control, storage hardware (device) control and management, and power control and management. The operating system program 112 processes normal communication between various hardware (devices) and software components (programs).

The application program 113 includes applications such as browser, e-mail, message, word processing, address book, widget, Digital Right Management (DRM), voice recognition, voice reproduction, position determining function, location based service, call, schedule management, and task management.

The graphical user interface program 114 includes at least one software component for providing a user interface using graphics between a user and the electronic device 100. That is, the graphical user interface program 114 includes at least one software component for displaying user interface information on the touch screen 130. The graphical user interface program 114 includes an instruction for, when the voice signal is received through the voice recognition, displaying the process result of the received voice signal. For example, when receiving the voice signal “question mark” in the text display mode, the graphical user interface program 114 includes an instruction for displaying “question mark” converted from the received voice signal to the text on the touch screen 130. For example, when receiving the voice signal “alarm” in the function execution mode, the graphical user interface program 114 includes an instruction for displaying an execution screen of the alarm function.

When the voice recognition is executed, the graphical user interface program 114 includes an instruction for displaying a graphic effect indicating the voice recognition mode type. For example, the graphical user interface program 114 includes an instruction for displaying the text indicating the current mode of the voice recognition. For example, the graphical user interface program 114 includes an instruction for displaying a message indicating the current mode of the voice recognition. For example, the graphical user interface program 114 includes an instruction for displaying a User Interface (UI) indicating the current mode of the voice recognition.

When the voice recognition is executed, the voice recognition program 115 can receive the voice signal from the microphone 152. That is, when the voice recognition is executed, the voice recognition program 115 can turn on the microphone 152 and receive the voice signal from the corresponding microphone 152.

When receiving the voice signal through the microphone 152, the voice recognition program 115 can identify the current voice recognition mode and process the received voice signal according to the identified mode. In so doing, the voice recognition program 115 can identify a preset voice recognition mode or store the received voice signal in the buffer of the memory, and then determine the voice recognition mode based on the information input from at least one sensor. Herein, the voice recognition mode can be at least one of the text display mode for displaying the text corresponding to the received voice signal when the voice signal is received, the function execution mode for conducting the function of the electronic device 100 corresponding to the received voice signal, or the waiting mode for aborting the voice signal reception.

When the identified voice recognition mode is the text display mode, the voice recognition program 115 can display the text corresponding to the received voice signal. More specifically, when the voice signal is received and the current voice recognition mode is the text display mode, the voice recognition program 115 can convert the received voice signal and display the text corresponding to the voice signal. For example, when the current voice recognition mode is the text display mode and the voice signal “Samsung” is received, the voice recognition program 115 can recognize the received voice signal “Samsung” as the text and display the text “Samsung” in a text input region of the executed voice recognition. For example, when the current voice recognition mode is the text display mode and the voice signal “Cut” is received, the voice recognition program 115 can recognize the received voice signal “Cut” as the text and display the text “Cut” in the text input region of the executed voice recognition.

When the identified voice recognition mode is the function execution mode, the voice recognition program 115 can perform the function of the electronic device 100 corresponding to the received voice signal. More specifically, when the voice signal is received and the current voice recognition mode is the function execution mode, the voice recognition program 115 can recognize the received voice signal as the command for performing the function of the electronic device 100, determine whether a function of the electronic device 100 mapped to the corresponding to the command, and perform the corresponding function when detecting the function for the corresponding command. For example, when the current voice recognition mode is the function execution mode and the voice signal “Samsung” is received, the voice recognition program 115 can recognize the received voice signal “Samsung” as the command, determine whether an function of the electronic device 100 is mapped to the command “Samsung”, and ignore the received voice signal when no function is mapped to the command “Samsung”. For example, when the current voice recognition mode is the function execution mode and the voice signal “Cut” is received, the voice recognition program 115 can recognize the received voice signal “Cut” as the command and determine whether a function of the electronic device 100 is mapped to the command “Cut”. In so doing, when the function corresponding to the command “Cut” cuts contents (e.g., text and image) displayed before the command “Cut”, the voice recognition program 115 can cut the contents displayed before the command “Cut”.

When the identified voice recognition mode is the waiting mode, the voice recognition program 115 can ignore the received voice signal. That is, when the voice signal is received and the current voice recognition mode is the waiting mode, the voice recognition program 115 can ignore every voice signal received in the waiting mode. For example, when the current voice recognition mode is the waiting mode and the voice signal “Samsung” is received, the voice recognition program 115 can temporarily store the received voice signal “Samsung” in the buffer and delete the buffered voice signal after a certain time. For example, when the current voice recognition mode is the waiting mode, the voice recognition program 115 can abort the voice signal reception by controlling the microphone 152.

When the voice recognition is executed, the motion detection program 116 can determine the voice recognition mode based on the information input from the at least one sensor. For example, the motion detection program 116 can determine the voice recognition mode based on angle information of the electronic device 100 input from the sensor for detecting an angle of the electronic device 100. For example, the motion detection program 116 can determine the voice recognition mode based on object distance information input from the sensor for detecting an object approaching the electronic device 100. For example, the motion detection program 116 can determine the voice recognition mode based on object motion information input from the sensor for detecting the motion of the object.

The processor 120 can include at least one processor (not shown) and a peripheral interface (not shown). The processor 120 executes a particular program (instruction set) stored in the memory 110 and conducts particular functions corresponding to the program.

The touch screen 130 is a touch-sensitive display and provides an interface for the touch input/output between the electronic device 100 and the user. The touch screen 130 is a medium for detecting the touch (or the contact) through a touch sensor (not shown), sending the detected touch input to the electronic device 100, and providing a visual output of the electronic device 100 to the user. That is, in response to the touch input, the touch screen 130 provides the visual output to the user based on text, graphics, and video.

The touch screen 130 includes a touch-sensitive surface for detecting the user's touch input, and detects the user touch input using haptic contact, tactile contact, or their combination. For example, the detected touch point of the touch screen 130 corresponds to a digit of the finger used to contact the touch-sensitive surface. On the touch-sensitive surface, the touch screen 130 detects the contact of an external device such as stylus pen. The detected contact is converted to an interaction corresponding to the user interface (e.g., a soft key) displayed on the touch screen 130.

The touch screen 130 can adopt various display technologies such as Liquid Crystal Display (LCD), Light Emitting Diode (LED), Light emitting Polymer Display (LPD), Organic LED (OLED), Active Matrix OLED (AMOLED) or Flexible LED (FLED). The touch screen 130 is not limited to a touch screen using those display technologies. The touch screen 130 can detect the contact start, the contact movement, or the contact abortion or end on the touch-sensitive surface using, but not limited to, various touch detection (sensing) techniques such as capacitive, resistive, infrared or surface sound wave detections. The touch screen 130 can display information indicating the current voice recognition mode. When the voice recognition mode is changed, the touch screen 130 can display information indicating the changed voice recognition mode.

The audio controller 150 is coupled to a speaker (not shown) and the microphone 152 to process the input and the output of the audio stream such as voice recognition, voice reproduction, digital recording, and telephone function. That is, the audio controller 150 outputs an audio signal through the speaker (not shown) and receives the user's voice signal through the microphone 152. The audio controller 150 receives the data stream through the processor 120, converts the received data stream to an electric signal, and then sends the converted electric signal to the speaker (not shown). The audio controller 150 receives the converted electric signal from the microphone 152, converts the received electric signal to the audio data stream, and then outputs the converted audio data stream to the processor 120. The audio controller 150 can include an attachable and detachable ear phone, head phone, or head set. The speaker (not shown) converts the electric signal received from the audio controller 150 to a sound wave audible by the user and outputs the sound wave. The microphone 152 converts the sound wave from the user or other sound sources to an electric signal. When the voice recognition is executed, the audio controller 150 can receive the user's voice signal by automatically driving the microphone 152.

FIG. 1B is a block diagram of the processor for recognizing the voice according to an example embodiment.

Referring to FIG. 1B, the processor 120 includes a voice recognition processor 122 and a motion detection processor 124.

When the voice recognition is executed, the voice recognition processor 122 can receive the voice signal from the microphone 152. That is, when the voice recognition is executed, the voice recognition processor 122 can turn on the microphone 152 and receive the voice signal from the corresponding microphone 152.

When receiving the voice signal through the microphone 152, the voice recognition processor 122 can identify the current voice recognition mode and process the received voice signal according to the identified mode. In so doing, the voice recognition processor 122 can identify the preset voice recognition mode or store the received voice signal in the buffer of the memory, and then determine the voice recognition mode based on the information input from the at least one sensor. Herein, the voice recognition mode can be at least one of the text display mode for displaying the text corresponding to the received voice signal when the voice signal is received, the function execution mode for operating the function of the electronic device 100 corresponding to the received voice signal, or the waiting mode for aborting the voice signal reception.

When the identified voice recognition mode is the text display mode, the voice recognition processor 122 can display the text corresponding to the received voice signal. More specifically, when the voice signal is received and the current voice recognition mode is the text display mode, the voice recognition processor 122 can convert the received voice signal and thus display the text corresponding to the voice signal. For example, when the current voice recognition mode is the text display mode and the voice signal “Samsung” is received, the voice recognition processor 122 can recognize the received voice signal “Samsung” as the text and display the text “Samsung” in the text input region of the executed voice recognition. For example, when the current voice recognition mode is the text display mode and the voice signal “Cut” is received, the voice recognition processor 122 can recognize the received voice signal “Samsung” as the text and display the text “Cut” in the text input region of the executed voice recognition.

When the identified voice recognition mode is the function execution mode, the voice recognition processor 122 can perform the function of the electronic device 100 corresponding to the received voice signal. More specifically, when the voice signal is received and the current voice recognition mode is the function execution mode, the voice recognition processor 122 can recognize the received voice signal as the command for performing the function of the electronic device 100, determine whether the function of the electronic device 100 mapped to the corresponding to the command, and perform the corresponding function when detecting the function for the corresponding command. For example, when the current voice recognition mode is the function execution mode and the voice signal “Samsung” is received, the voice recognition processor 122 can recognize the received voice signal “Samsung” as the command, determine whether an function of the electronic device 100 is mapped to the command “Samsung”, and ignore the received voice signal when no function is mapped to the command “Samsung”. For example, when the current voice recognition mode is the function execution mode and the voice signal “Cut” is received, the voice recognition processor 122 can recognize the voice signal “Cut” as the command and determine whether a function of the electronic device 100 is mapped to the command “Cut”. In so doing, when the function corresponding to the command “Cut” cuts contents (e.g., text and image) displayed before the command “Cut”, the voice recognition processor 122 can cut the contents displayed before the command “Cut”.

When the identified voice recognition mode is the waiting mode, the voice recognition processor 122 can ignore the received voice signal. That is, when the voice signal is received and the current voice recognition mode is the waiting mode, the voice recognition processor 122 can ignore every voice signal received in the waiting mode. For example, when the current voice recognition mode is the waiting mode and the voice signal “Samsung” is received, the voice recognition processor 122 can temporarily store the received voice signal “Samsung” in the buffer and delete the buffered voice signal after a certain time. For example, when the current voice recognition mode is the waiting mode, the voice recognition processor 122 can abort the voice signal reception by controlling the microphone 152.

When the voice recognition is executed, the motion detection processor 124 can determine the voice recognition mode based on the information input from the at least one sensor. For example, the motion detection processor 124 can determine the voice recognition mode based on the angle information of the electronic device 100 input from the sensor for detecting the angle of the electronic device 100. For example, the motion detection processor 124 can determine the voice recognition mode based on the object distance information input from the sensor for detecting the object approaching the electronic device 100. For example, the motion detection processor 124 can determine the voice recognition mode based on the object motion information input from the sensor for detecting the motion of the object.

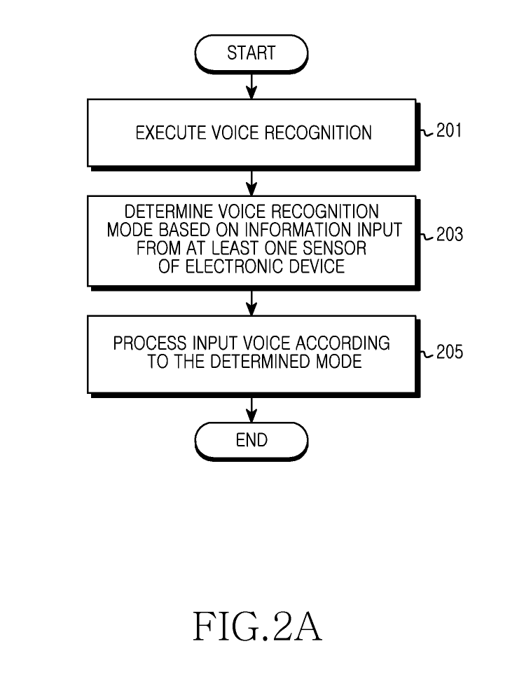

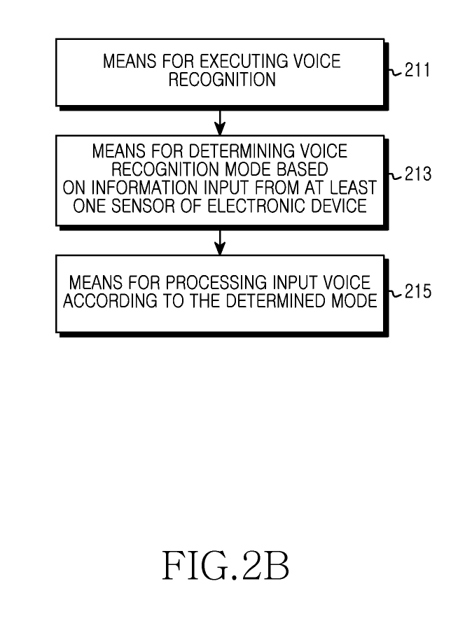

FIG. 2A depicts an example sequence of steps for processing the input voice signal according to the voice recognition mode in the electronic device 100 according to an example embodiment.

Referring to FIG. 2A, the electronic device 100 can execute the voice recognition in step 201. When the menu or the icon for executing the voice recognition is selected, the electronic device 100 can execute the voice recognition.

In step 203, the electronic device 100 can determine the voice recognition mode based on the information input from the at least one sensor. More specifically, the electronic device 100 can receive the information from the at least one sensor and then determine the voice recognition mode based on the input information. In so doing, the mode of the electronic device 100 can be at least one of the text display mode, the function execution mode, or the waiting mode.

In step 205, the electronic device 100 can process the input voice according to the determined mode. When the voice recognition mode of the electronic device 100 is the text display mode, the electronic device 100 can convert the received voice signal to the text and display the converted text. When the voice recognition mode of the electronic device 100 is the function execution mode, the electronic device 100 can recognize the received voice signal as the command and perform the function corresponding to the recognized command. When the voice recognition mode of the electronic device 100 is the waiting mode, the electronic device 100 can ignore the received voice signal.

FIG. 2B depicts means for processing the input voice signal according to the voice recognition mode in the electronic device according to an example embodiment.

Referring to FIG. 2B, the electronic device 100 includes a means 211 for executing the voice recognition. In so doing, the electronic device 100 can include the means, such as microphone, for receiving the voice signal from the user.

The electronic device 100 includes a means 213 for determining the voice recognition mode based on the information input from the at least one sensor. The electronic device 100 can include at least one sensor, and the sensor of the electronic device 100 can include at least one of the gyro sensor, the tilt sensor, the motion sensor, or the proximity sensor.

The electronic device 100 includes a means 215 for processing the input voice according to the determined mode. The electronic device 100 can include at least one of a means for converting the received voice signal to the text, a means for performing the function corresponding to the received voice signal, or a means for ignoring the received voice signal.

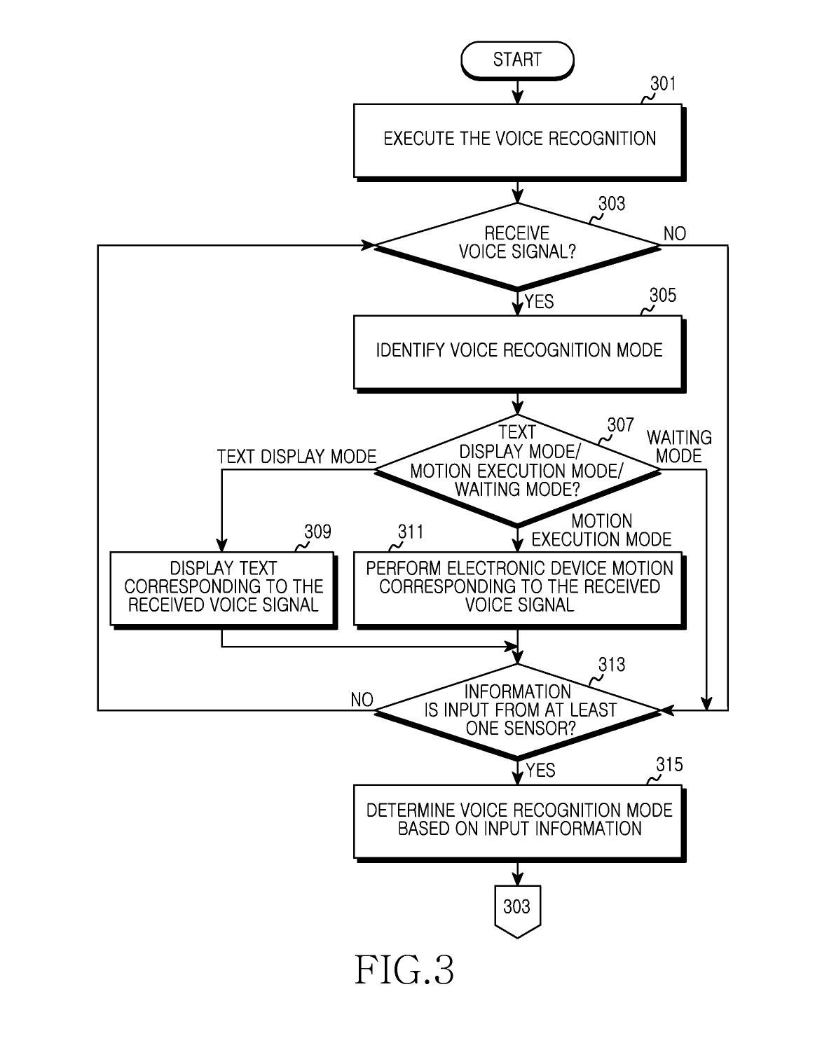

FIG. 3 depicts an example sequence of steps for processing the input voice signal based on information input from the sensor in the electronic device 100 according to an example embodiment.

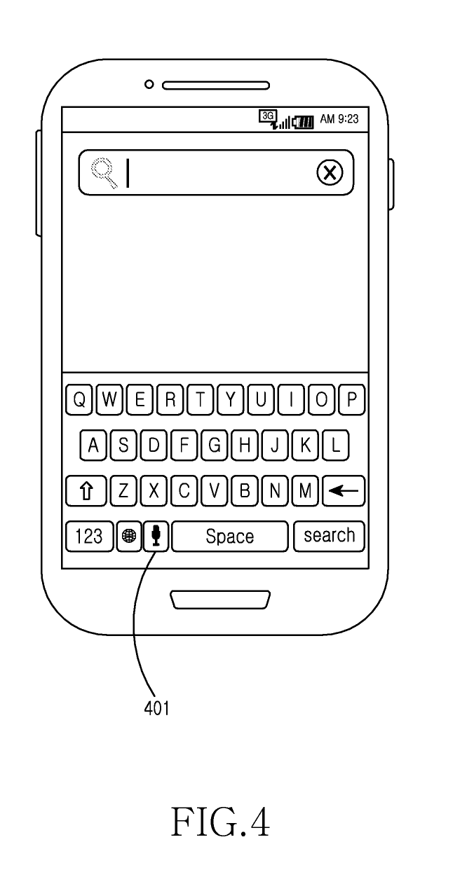

Referring to FIG. 3, the electronic device 100 executes the voice recognition in step 301. For example, when a menu 401 for the voice recognition is selected as shown in FIG. 4, the electronic device 100 can execute the voice recognition.

In step 303, the electronic device 100 determines whether the voice signal is received. That is, the electronic device 100 determines whether the user's voice signal is received through the microphone 152.

Upon receiving the voice signal, the electronic device 100 identifies the voice recognition mode in step 305. In step 307, the electronic device 100 determines whether the identified voice recognition mode is the text display mode, the function execution mode, or the waiting mode.

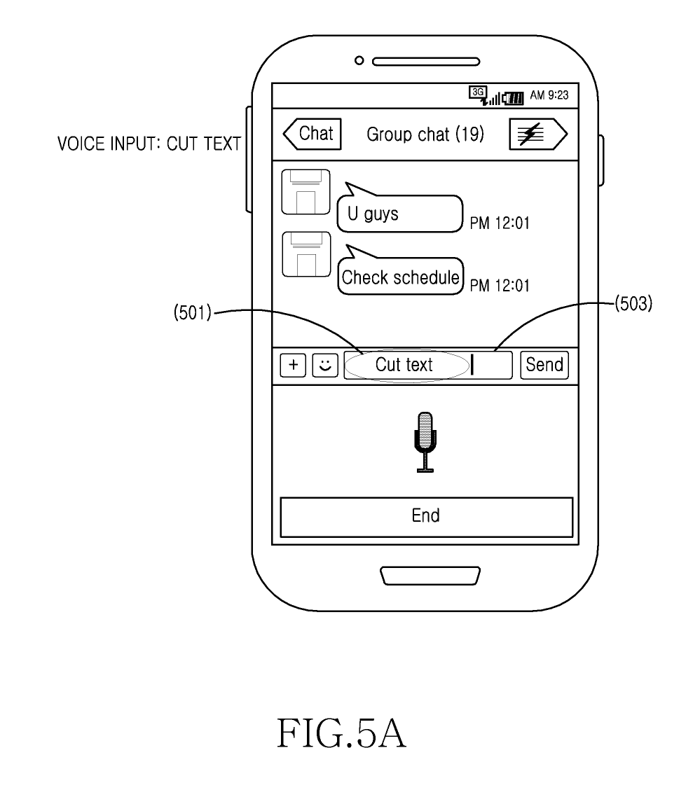

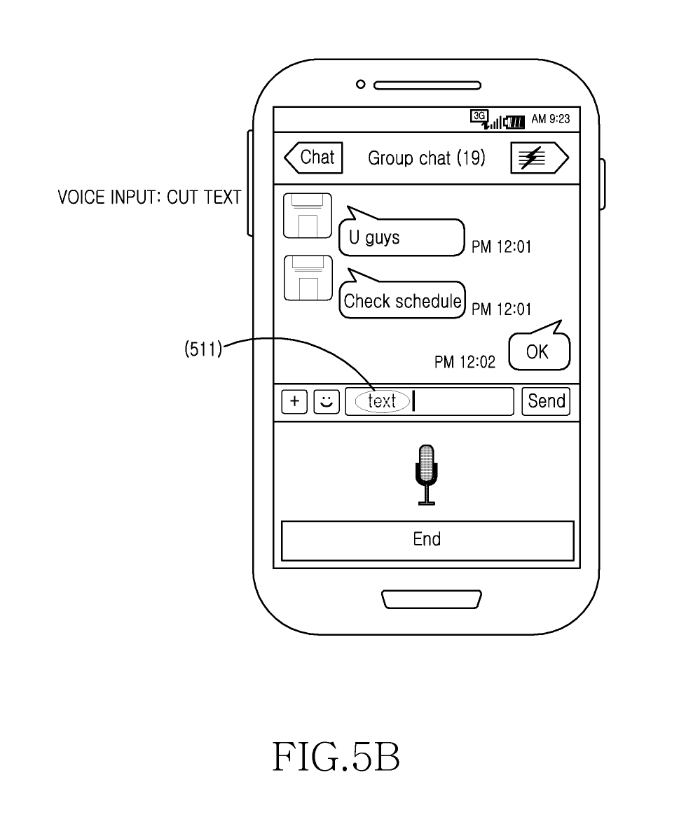

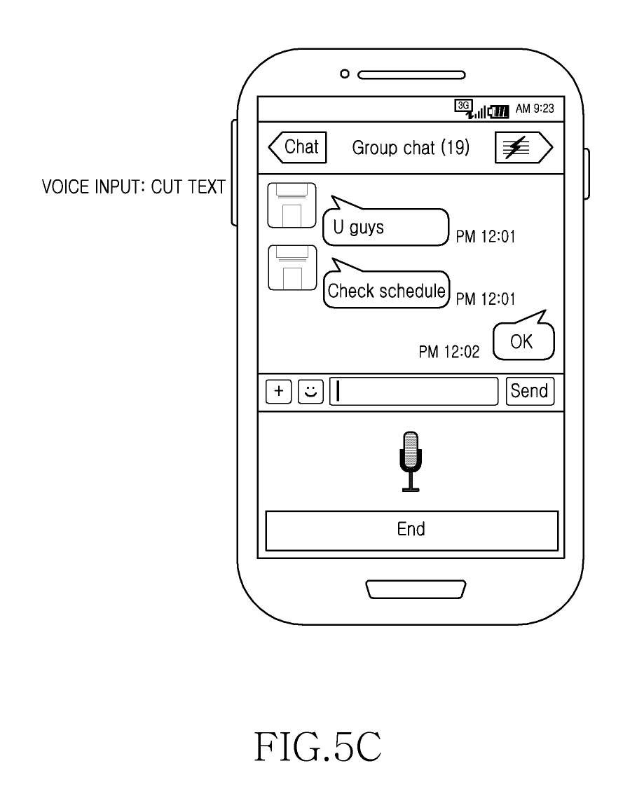

When the voice recognition mode is the text display mode, the electronic device 100 displays the text corresponding to the received voice signal in step 309. More specifically, when the identified voice recognition mode is the text display mode, the electronic device 100 can convert the received voice signal to the text and display the converted text in the text display region. For example, when receiving the voice signal “Cut text” in the text display mode, the electronic device 100 can convert the received voice signal to the text and display the converted text “Cut text” 501 in the text display region 503 as shown in FIG. 5A. Next, the electronic device 100 can determine whether the information is input from the at least one sensor in step 313.

When the voice recognition mode is the function execution mode, the electronic device 100 performs its function corresponding to the received voice signal in step 311. More specifically, when the identified voice recognition mode is the function execution mode, the electronic device 100 can recognize the received voice signal as the command for the function, determine whether the function of the electronic device 100 is mapped to the corresponding command, and then perform the corresponding function when determining the function for the corresponding command. For example, when receiving the voice signal “Cut text” in the function execution mode, the electronic device 100 recognizes the received voice signal “text” and “Cut” as the command, and determines whether the function is mapped to “text” and “Cut”. The electronic device 100 confirms no function mapped to the command “text”, converts the voice signal “text” to the text, and displays the text. Next, the electronic device 100 can confirm that the function mapped to the command “Cut” cuts the displayed contents, and cut the displayed text “text” 511 before the command “Cut” as shown in FIG. 5B. Next, the electronic device 100 can determine whether the information is input from the at least one sensor in step 313.

When the voice recognition mode is the waiting mode, the electronic device 100 can determine whether the information is input from the at least one sensor in step 313. When the voice recognition mode is the waiting mode, as shown in FIG. 5C, the electronic device 100 can ignore the received voice signal. For example, when receiving the voice signal “Cut text” in the waiting mode, the electronic device 100 can ignore the received voice signal “Cut text”.

When no information is input from the at least one sensor, the electronic device 100 goes back to step 303.

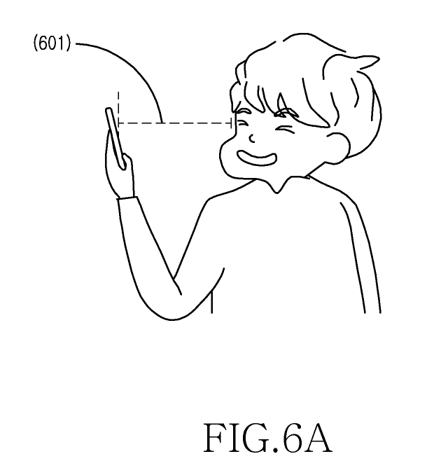

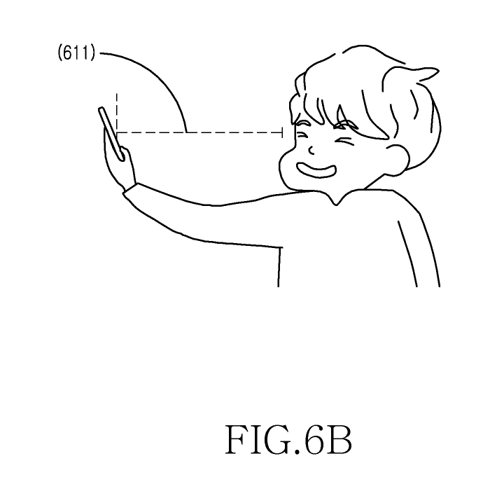

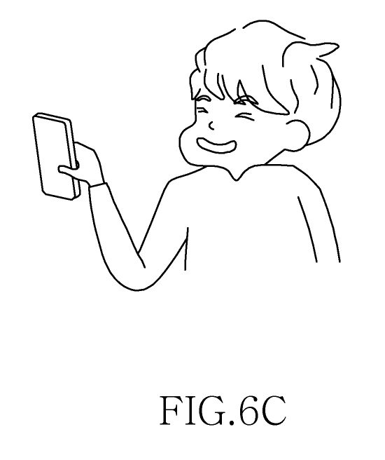

By contrast, when receiving the information from the at least one sensor, the electronic device 100 determines the voice recognition mode based on the input information in step 315. That is, the electronic device 100 can set the voice recognition mode to one of the text display mode, the function execution mode, and the waiting mode, based on the information from the at least one sensor. In so doing, the electronic device 100 can obtain the input information and thus determine the voice recognition mode corresponding to the information. For example, with the proximity sensor, the electronic device 100 can determine the text display mode as the voice recognition mode when an object distance 601 detected by the proximity sensor falls within a first threshold distance as shown in FIG. 6A. For example, with the proximity sensor, the electronic device 100 can determine the function execution mode as the voice recognition mode when an object distance 611 detected by the proximity sensor is greater than the first threshold distance and smaller than a second threshold distance as shown in FIG. 6B. For example, with the proximity sensor, the electronic device 100 can determine the waiting mode as the voice recognition mode when no object is detected within the second threshold distance from the electronic device 100 as shown in FIG. 6C.

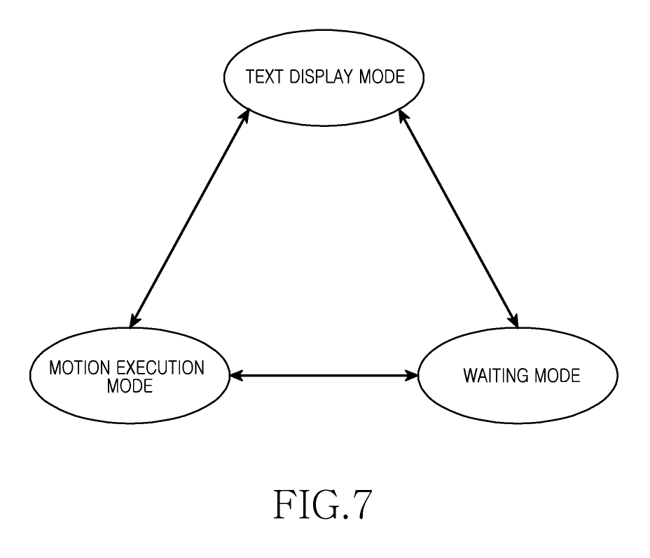

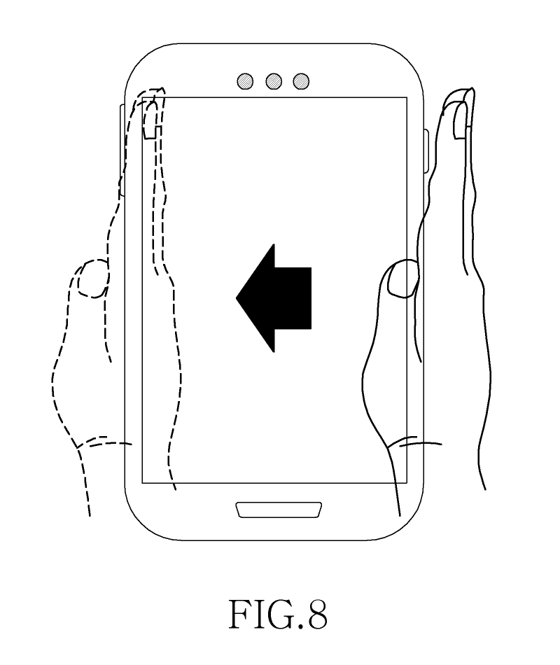

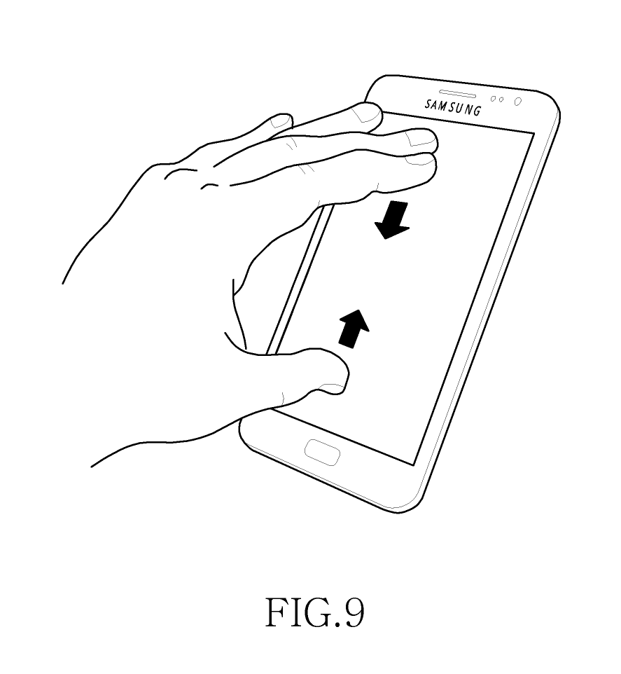

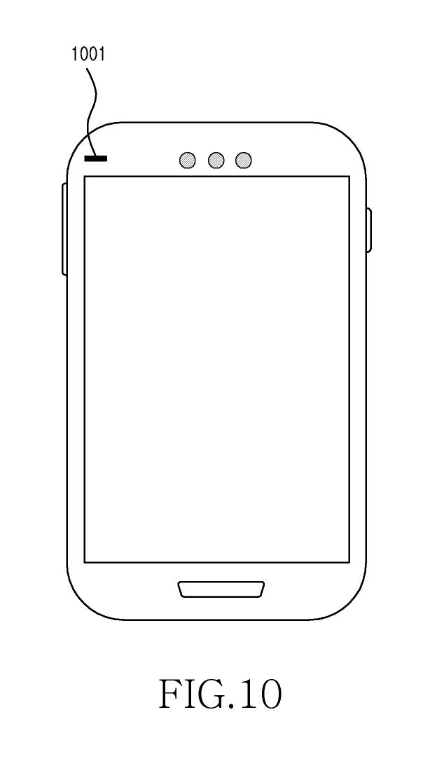

When the information is input from the at least one sensor, the electronic device 100 can set the three voice recognition modes in order. For example, when the information is input from the at least one sensor, the electronic device 100 can set the voice recognition mode by toggling the text display mode, the function execution mode, and the waiting mode in order as shown in FIG. 7. For example, when the object motion information from the right to the left is input from the motion sensor of the electronic device 100 as shown in FIG. 8, the electronic device 100 can toggle the voice recognition modes in order. When the current voice recognition mode is the text display mode, the next mode is the function execution mode, and the object motion from the right to the left is detected, the electronic device 100 can switch the voice recognition mode from the text display mode to the function execution mode. For example, when the object pinch motion information is input from the motion sensor of the electronic device 100 as shown in FIG. 9, the electronic device 100 can toggle the voice recognition modes in order. When the current voice recognition mode is the function execution mode, the next mode is the waiting mode, and the pinch of the object is detected, the electronic device 100 can switch the voice recognition mode from the function execution mode to the waiting mode. In so doing, the electronic device 100 can indicate the current voice recognition mode through an LED lamp 1001 as shown in FIG. 10. For example, the electronic device 100 can set the LED lamp 1001 in red for the text display mode, in yellow for the function execution mode, and in blue in the waiting mode.

The example embodiments and various functional operations described herein can be implemented in computer software, firmware, hardware, or in combinations of one or more of them including the structures disclosed in this specification and their structural equivalents. The example embodiments can be implemented as one or more computer program products, that is, one or more data processors, or one or more modules of computer program instructions encoded on a computer-readable medium to control the devices.

The computer-readable medium may be a machine-readable storage medium, a machine-readable storage substrate, a memory device, a material affecting a machine-readable propagated stream, or a combination of one or more of these. The term ‘data processor’ encompasses every device, apparatus, and machine including, for example, a programmable processor, a computer, a multiple processors, or a computer, for processing data. The device can be added to the hardware and include program code for creating an execution environment of a corresponding computer program, for example, code for constituting processor firmware, a protocol stack, a database management system, an operating system, or a combination of one or more of these.

Methods according to example embodiments disclosed in claims and/or specification can be implemented in a form of hardware, software, or a combination of the hardware and the software.

In a case of implementation of the software form, a computer-readable storage medium storing one or more programs (i.e., software modules) can be provided. One or more programs stored in the computer-readable storage medium are configured to be executable by one or more processors within the electronic device 100. One or more programs include instructions for enabling the electronic device 100 to execute the methods according to the example embodiments disclosed in the claims and/or specification.

These programs (i.e., software modules or software) can be stored in a Random Access Memory (RAM), a nonvolatile memory including a flash memory, a Read Only Memory (ROM), an Electrically Erasable Programmable ROM (EEPROM), a magnetic disk storage device, a Compact Disk ROM (CD-ROM), a Digital Versatile Disk (DVD) or an optical storage device of other form, and a magnetic cassette. Or, the programs can be stored in a memory implemented by a combination of some or all of them. Also, each configuration memory may be included in plural.

Further, the programs can be stored in an attachable storage device accessible to the electronic device through a communication network such as the Internet, an intranet, a Local Area Network (LAN), a Wireless LAN (WLAN) or a Storage Area Network (SAN), or a communication network implemented by a combination of them. The attachable storage device can access the electronic device 100 through an external port.

The functions and process steps herein may be performed automatically or wholly or partially in response to user command. An activity (including a step) performed automatically is performed in response to executable instruction or device operation without user direct initiation of the activity.

The terms “unit” or “module” referred to herein is to be understood as comprising hardware such as a processor or microprocessor configured for a certain desired functionality, or a non-transitory medium comprising machine executable code, in accordance with statutory subject matter under 35 U.S.C. §101 and does not constitute software per se.

While the invention has been shown and described with reference to certain example embodiments thereof, it will be understood by those skilled in the art that various changes in form and details may be made therein without departing from the disclosure of the invention as defined by the appended claims and their equivalents.

What is claimed is:

1. A method in an electronic device, comprising:
executing a voice recognition function;
setting a voice recognition mode based on information input from at least one sensor of the electronic device; and
processing an input voice according to the set voice recognition mode,
wherein the voice recognition mode comprises at least one of a text display mode, an electronic device function execution mode, and a waiting mode.

2. The method of claim 1, further comprising:
identifying the voice recognition mode by a pre-defined association between the information and the at least one of the text display mode, the function execution mode, and the waiting mode.

3. The method of claim 1, further comprising setting a different voice recognition mode in response to detecting a mode switch input by the at least one sensor.

4. The method of claim 1, further comprising:
in response to the set voice recognition mode being the text display mode, converting the input voice to a text; and
displaying the converted text on a display.

5. The method of claim 4, further comprising inputting the converted text to a text input field of the display.

6. The method of claim 1, further comprising:
in response to the set voice recognition mode being the function execution mode, identifying and executing a function of the electronic device is mapped to the input voice.

7. The method of claim 1, further comprising:
in response to the set voice recognition mode being the waiting mode, ignoring the input voice.

8. The method of claim 1, wherein the at least one sensor comprises at least one of a proximity sensor, a tilt sensor, a gyro sensor, and a motion sensor.

9. The method of claim 1, further comprising:
adjusting a color of a lamp indicator of the electronic device according to the set voice recognition mode.

10. The method of claim 1, further comprising:
displaying a message indicating the set voice recognition mode.

11. An electronic device comprising:
a touch-sensitive display;
a microphone; and
a processor configured to:
execute a voice recognition function,
set a voice recognition mode based on information input from at least one sensor of the electronic device, and
process an input voice according to the set voice recognition mode,
wherein the voice recognition mode comprises at least one of a text display mode, a function execution mode, and a waiting mode.

12. The electronic device of claim 11, the processor further configured to:
identifying the voice recognition mode by a pre-defined association between the information and the at least one of the text display mode, the function execution mode, and the waiting mode.

13. The electronic device of claim 11, the processor further configured to set a different voice recognition mode in response to detecting a mode switch input by the at least one sensor.

14. The electronic device of claim 11, the processor further configured to:
in response to the set voice recognition mode being the text display mode, convert the input voice to a text; and
display the converted text on the touch-sensitive display.

15. The electronic device of claim 14, the processor configured to:
input the converted text to a text input field of the touch-sensitive display.

16. The electronic device of claim 11, the processor further configured to:
in response to the set voice recognition mode being the function execution mode, identify and execute a function of the electronic device mapped to the input voice.

17. The electronic device of claim 11, the processor further configured to:
in response to the set voice recognition mode being the waiting mode, ignore the input voice.

18. The electronic device of claim 11, wherein the at least one sensor comprises at least one of a proximity sensor, a tilt sensor, a gyro sensor, and a motion sensor.

19. The electronic device of claim 11, the processor further configured to:
adjust a color of a lamp indicator of the electronic device according to the set voice recognition mode.

20. The electronic device of claim 11, the processor further configured to:
display a message indicating the set voice recognition mode.
